(19) United States
(12) Patent Application Publication
(10) Pub. No.: US 2007/0124445 A1
(43) Pub. Date: May 31, 2007

(54) BROWSER ADAPTATION FOR CONTEXT BASED NAVIGATION

(76) Inventors: ROBERT HARRIS, Christchurch (GB); KEVIN RUSSELL, Eastleigh (GB); WILLIAM YATES, Portsmouth (GB)

Correspondence Address: IBM CORPORATION;INTELLECTUAL PROPERTY LAW, 11400 BURNET ROAD, AUSTIN, TX, 78758, US

(21) Appl. No.: 11/551,540

(22) Filed: Oct. 20, 2006

(30) Foreign Application Priority Data
Nov. 26, 2005 (GB) 0524166.6

(51) Int. Cl. G06F 15/173

(52) U.S. Cl. 709/223

(57) ABSTRACT

An interceptor component for generating a uniform resource locator for associating with a forward navigation button for transmitting to a browser application, the interceptor component comprising: an inbound/outbound controller for determining whether a received data packet is an inbound request; a parsing component for identifying a unique identifier and a uniform resource locator of the determined inbound request, storing the unique identifier and the uniform resource locator; the inbound/outbound controller receiving an outbound response to the inbound request and identifying the unique identifier within the outbound response and locating the uniform resource locator associated with the unique identifier; and the inbound/outbound controller performing a second look-up to locate a uniform resource locator which can be navigated to in a forward navigation operation and inserting the located uniform resource locator into the outbound response and transmitting the response to a requesting client device.

### FIELD OF THE INVENTION

The invention relates to the field of Internet browsing. In particular the invention relates to generating context sensitive URI's in a client server environment.

### BACKGROUND OF THE INVENTION

Browser applications are used to retrieve web pages located on web servers for viewing at a client device. Prior art web browsers include functionality to aid page navigation during a user session. One example of this type of functionality is the ability to review a previously displayed web page.

The ‘review a previously displayed web page’ functionality is controlled by forward and back buttons located on the tool bar of the browser. These buttons often appear as back and forward pointing arrows in a fixed position on the browser's display area. When a page is accessed by the browser the page is typically stored in a local cache. In order to access a previously viewed web page by either the forward button or the back button, the forward or back button accesses the local cache and retrieves the appropriate web page. Thus, the browser's cache of previously viewed pages allows the user to navigate to pages already viewed within their current browsing session.

Internet applications which are executed using a browser for user input and output are accessed through the HTTP protocol which is known in the art as a stateless protocol. However, prior art Internet applications require the browser to send ‘state’ information with each request in order for the application to maintain information about the user's session, therefore providing relevant information to the user. But, the application being executed cannot rely on any consistent operational state being valid throughout the lifetime of a user interaction. This often means a page stored in the browser's cache becomes invalid due to it comprising out of date information. Attempts to redisplay a page will result in a navigational error response. Such navigational errors range from the page not redisplaying to inaccurate or invalid information being displayed.

Existing prior art solutions attempt to solve the problem by using a browser in ‘kiosk mode’. Kiosk mode involves ignoring the problem of navigational errors by removing the navigation buttons from the browser interface. The removal of the navigational buttons presents a number of usability issues for users, namely, not being able to use forward and back buttons to correct a mistake.

Another instance where prior art navigational buttons fail to provide useful functionality is when the user is browsing a page which is within a larger sequence of pages. Examples of sequential chains are in search engine result pages. Due to the large number of potential results, the results are split into several pages. Each page often contains a link to at least the next page to be viewed and the previous page. These commonly appear in the browser as:
<PREV> <1> <2> <3> <4> <5> <6> <NEXT>

This method of linking to the next and/or previous page in the chain is a direct opposition from the browser back and forward buttons. A user at the first page in the chain at the start of a browsing session wishing to navigate to the ‘next’ page may attempt to use the ‘forward’ browser navigation button. However, due to the operation of the browser cache this functionality will not be available (as the page has not been viewed and thus the page is not in the cache). Therefore, the user has to use the links provided on the page. Similarly, if the user uses the links to navigate directly to the nth page in the chain and then wishes to access the previous page in the chain, the backward browser control does not provide this functionality. For example, after viewing pages 1, 2, 9 the use of the prior art back button will redisplay page 2 when page 8 is really required.

Clearly, these approaches are unsatisfactory for normal users. In the case of disabled users the situation is untenable. Visually restricted users have to use screen readers to examine the web page displayed in the browser and thus need some uniform and clear way of navigating through a set of web pages.

Another prior art example which tries to address this problem is when specialised HTML constructs are used to attach attributes to the forward and back buttons. These attributes are hard coded into the HTML constructs and although they may mimic forward and back functionality they are very much static in function. This is because if the user navigates to a page which is not listed in the HTML constructs the forward or back button can not function. The only way to compensate for this is to manually edit the HTML constructs to add another uniform resource locator (URI) attribute.

This problem is compounded further when using multimedia applications and HTML constructs can not be embedded into the page.

Thus there is a need within the prior art for an improved method of navigation using the forward and back navigation buttons.

### SUMMARY OF THE INVENTION

Viewed from a first aspect, the present invention comprises an interceptor component for generating a uniform resource locator for associating with a forward navigation button for transmitting to a browser application, the interceptor component comprising: an inbound/outbound controller for determining whether a received data packet is an inbound request; a parsing component for identifying a unique identifier and a uniform resource locator of the determined inbound request, storing the unique identifier and the uniform resource locator; the inbound/outbound controller receiving an outbound response to the inbound request and identifying the unique identifier within the outbound response and locating the uniform resource locator associated with the unique identifier; and the inbound/outbound controller performing a second look-up to locate a uniform resource locator which can be navigated to in a forward navigation operation and inserting the located uniform resource locator into the outbound response and transmitting the response to a requesting client device.

Advantageously, the present invention provides for identifying the URI's which can be navigated to via forward and back buttons within a browser environment. Each time a request for a resource is transmitted to a web server, the interceptor identifies a pair of URI's which are wrapped in HTTP constructs for inserting within the HTTP header of an HTTP data packet. Thus allowing URI's to be identified for attaching to the forward and back navigation buttons in a multi media environment where executable code can not be embedded into the multi media.

Preferably, the present invention comprises an interceptor component further comprising the inbound/outbound controller locating a uniform resource locator which can be navigated to in a back navigation operation and inserting the located uniform resource locator into the outbound response.

Preferably, the present invention comprises an interceptor component wherein the outbound response is received by a browser operating on a requesting device and the browser application attaches the forward URI to the respective forward button.

Preferably, the present invention comprises an interceptor component wherein the outbound response is received by a browser operating on a requesting device and the browser application attaches the back URI to the respective back button.

Preferably, the present invention comprises an interceptor component wherein the unique identifier is an IP address or a state token.

Preferably, the present invention comprises an inceptor component further comprising a workflow map detailing at least one URI which can be navigated to from the URI identified in the inbound request.

Preferably, the present invention provides an interceptor component further comprising a state management component for parsing the workflow map to match the URI of the outbound response with a URI identified within a node of the workflow map.

Preferably, the present invention comprises an interceptor component wherein the state management component on identifying a match traverses the workflow map in a plurality of directions to locate URIs which can be navigated to from the URI identified in the outbound response.

Preferably, the present invention comprises an interceptor component wherein each URI of the URI pair are packaged into an HTTP construct for inserting into an HTTP header of the outbound response.

Preferably, the present invention provides an interceptor component wherein each HTTP construct identifies a forward navigation action and a back navigation action.

Preferably, the present invention provides an interceptor component wherein the workflow map further comprises data relating to the operating workload capacity of a server identified within the URI.

Preferably, the present invention provides an interceptor component wherein the inbound/outbound component performs load balancing operations in response to the operating workload capacity of the server.

Viewed from a second aspect, the present invention provides a browser application for requesting resources from servers operating in a data process environment and adapted for receiving an outbound response as described above.

Viewed from a third aspect the present invention provides a method for generating a uniform resource locator for associating with a forward navigation button for transmitting to a browser application, comprising the steps of: an determining whether a received data packet is an inbound request; identifying a unique identifier and a uniform resource locator of the determined inbound request, storing the unique identifier and the uniform resource locator; receiving an outbound response to the inbound request and identifying the unique identifier within the outbound response and locating the uniform resource locator associated with the unique identifier; and performing a second look-up to locate a uniform resource locator which can be navigated to in a forward navigation operation and inserting the located uniform resource locator into the outbound response and transmitting the response to a requesting client device.

Viewed from a fourth aspect, the present invention provides a computer program product comprising computer readable medium including computer program code, which when executed by a computer cases the computer to perform the method as described above.

### BRIEF DESCRIPTION OF THE DRAWINGS

Embodiments of the invention are described below in detail, by way of example only, with reference to the accompanying drawings in which:

FIG. 1 is a block diagram of a heterogeneous computing environment in which a preferred embodiment of the invention may be implemented;

FIG. 2 is a block diagram showing the components of a web server as is known in the art;

FIG. 3 is a block diagram showing the components of a web browser in which a preferred embodiment of the invention may be implemented;

FIG. 4 is a block diagram showing the component of the inceptor component in accordance with a preferred embodiment of the present invention;

FIG. 5 is a block diagram of a hierarchical web site as is known in the art;

FIG. 6 is a block diagram showing an another example of the inceptor component in accordance with a preferred embodiment of the present invention;

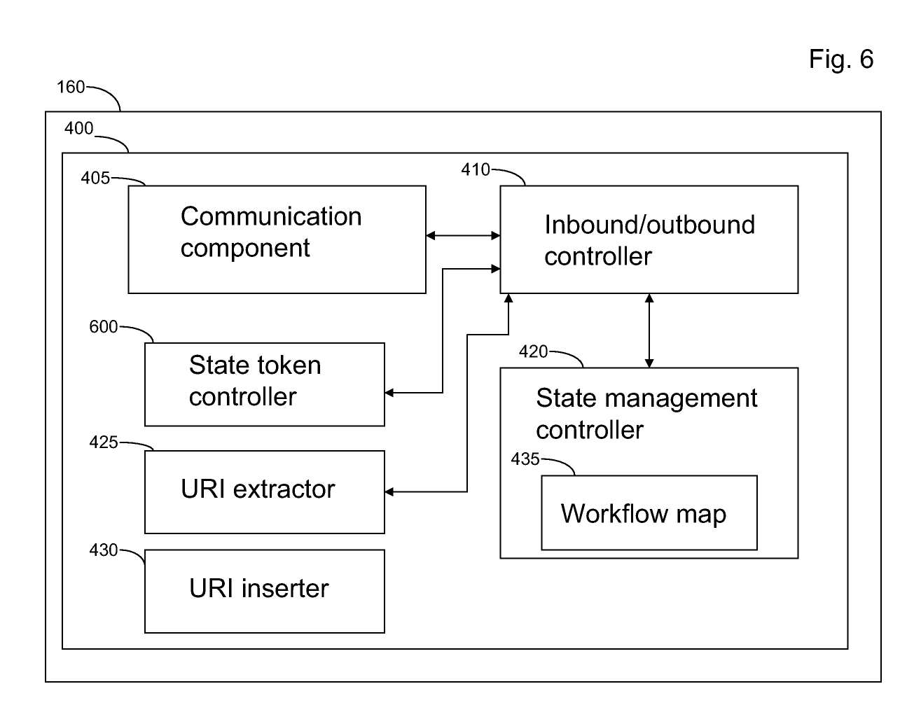

FIG. 7 is a flow chart detailing the operational steps of the inceptor component in accordance with a preferred embodiment of the present invention; and

FIG. 8 is a sequence diagram showing the sequence of interactions of the interceptor component with other data processing components.

### DETAILED DESCRIPTION OF THE INVENTION

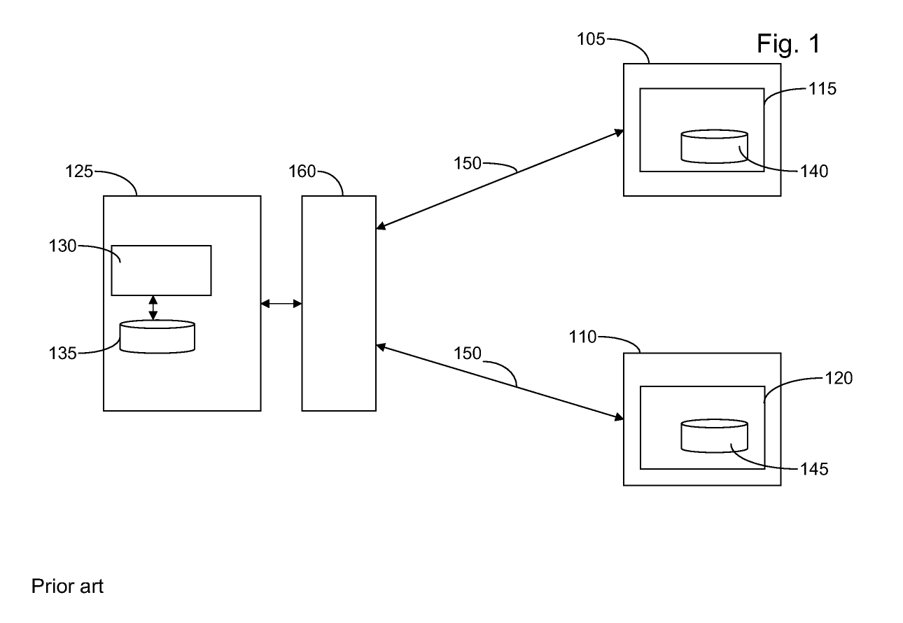

FIG. 1 is a representation of a distributed computing architecture. A number of client devices 105, 110 connect to a network 150, such as, the Internet. The client devices 105, 110 may comprise a number of different computing devices such as personal computers, mobile phones and gaming machines etc. Client devices 105, 110 request access to resources, such as, multimedia applications comprising web services, music services and video on-demand services, for example. Typically, the client device 105, 110 interacts with the network 150 by utilising the protocols within the OSI protocol stack, for example via HTTP and TCP/IP. The network 150 may comprise any network type, for example, a local area network, a wide area network, a metropolitan network and a wireless network.

Each client device 105, 110 comprises software for allowing a user to specify a request for a resource. For example, the software may comprise a conventional web browser 115,120 or a specialised web browser operating on a media player or mobile phone etc.

In order to access a requested resource, client devices 105, 110 transmit, via a web browser 115, 120, a request for the resource to the service provider. The service provider locates the request and providing that the requester's subscription allows the request for the resource transmits the requested resource back to the requester. The service provider manages a network of web servers 130 and gateways 160 etc.

The client computer 105, 110 is not limited to a particular type of data processing apparatus, and may be a conventional desktop or laptop personal computer, a personal digital assistant (PDA) or another specialized data processing device which is capable of running a browser application. The client computers 105, 110 may connect to a network of data processing systems via wireless or hard-wired connections. Similarly, the server 125 can be any data processing apparatuses which are capable of running a web server 130, directory server or similar server program and a data store 135 for storing a plurality of web pages. Software-implemented elements of the embodiment described in detail below are not limited to any specific operating system or programming language.

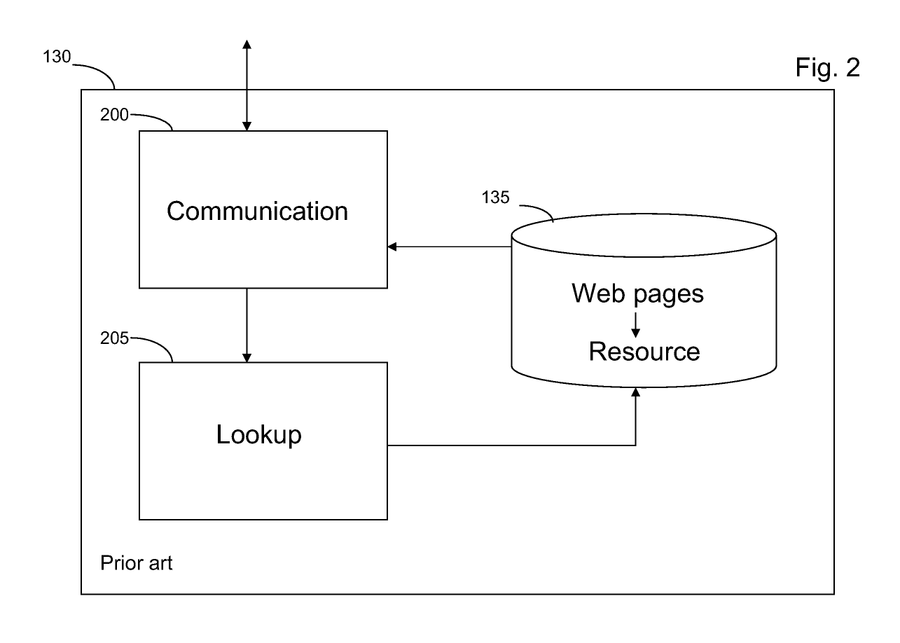

Referring to FIG. 2 the web server 130 comprises a number of components in order to serve requests from client devices 105, 110 for resources, such as, media files for example.

The web server 130 comprises a communication component 200 for receiving requests from client devices 105, 110 and for sending replies in the form of requested media files and other resources to the requesting client device 105, 110, a data store 135 for storing media files and a lookup component 205 for parsing a client request in order to locate in the data store 135 the requested media file. Each of these components will now be explained in turn. The communication component 200 receives requests for resources from requesting client devices 105, 110 and is operable with the HTTP protocol and other network protocols of the OSI stack, including the TCP/IP protocol.

The request for a resource comprises a uniform resource locator (URI) which identifies the resource being requested and its location. The communication component 200 communicates the request for the resource to the lookup component 205. A lookup is performed on the URI to identify the pathname which identifies the location in the data store of the requested resource. The lookup component 205 sends a request to the identified location and retrieves the media file from the data store 135. The requested resource is transmitted to the communication component 200 by the lookup component 205 for communicating across the network 150 to the requesting client device 105, 110.

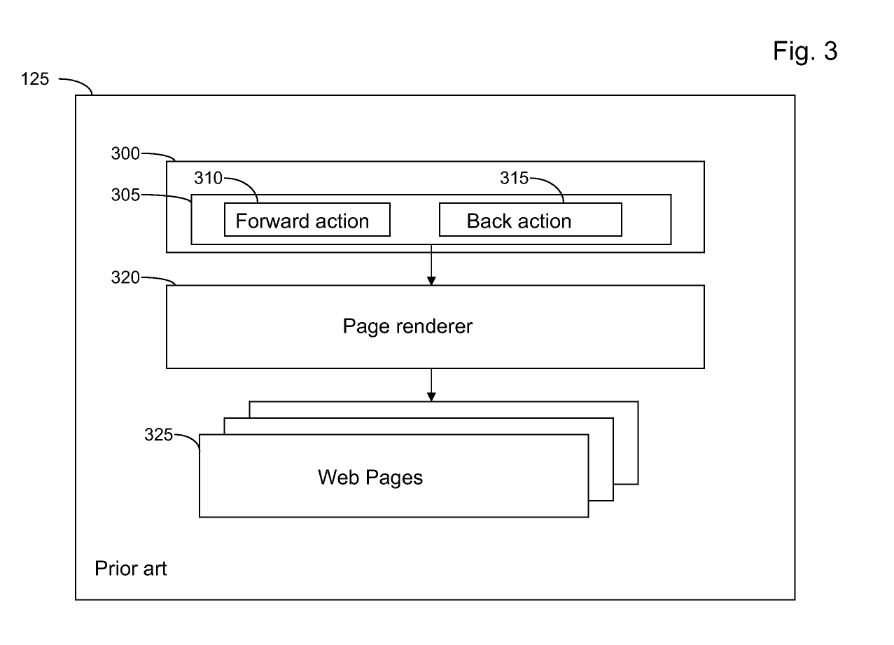

FIG. 3 details the main components of a known prior art browser 115, 120. The components comprise a user interface 300 comprising a display window and an action bar 305 comprising a number of buttons that can be selected by the user for performing a number of actions with respect to browsing web pages 325. For example, forward 310 and back buttons 315 for browsing previously displayed web pages 325. A URI is typed in to the address bar located on the action bar 305 of the browser window 115, 120.

The browser 115, 120 initiates a request for the resource by establishing a TCP connection to a particular port on the web server 130. The web server 130 listens on the particular port and waits for the browser request, which may be in the form of ‘Get/HTTP/1.1, followed by a MIME message having informational header strings that describe aspects of the request. Upon receiving the request, the web server 130 sends back a response string, such as “200 OK”, and a message of its own, the body of the response string being the requested resource. Example 1 shows a typical HTTP request/reply conversation between a client device 105, 110 and a web server 130.

### EXAMPLE 1

Client Request
GET/index.html HTTP/1.1
Host: www.mymusic.com

Server Response
HTTP/1.1 200 OK
Date; Tuesday 22 November 2005 14:19 GMT
Server: Apache/1.3.25
Last modified: Saturday 2 July 2005 12:01 GMT
Content-length 524
Connection: Active
Content type: mps, wav, wmv; charset UTF-16

The web server 130 transmits the request back to the browser 115, 120 for rendering by a page renderer component 320.

Forward and back buttons are then used by the user to navigate through previously viewed web pages. If the user has just started a browsing session, the forward 310 and back buttons 315 are greyed out until the user has visited another web page 325 and it is only at that point, URI's are attached to the forward and back buttons in order to provide navigation functionality of previously viewed web pages 325. This is because, previously, the requested resource had not been visited by the user and therefore was not stored within the browser cache.

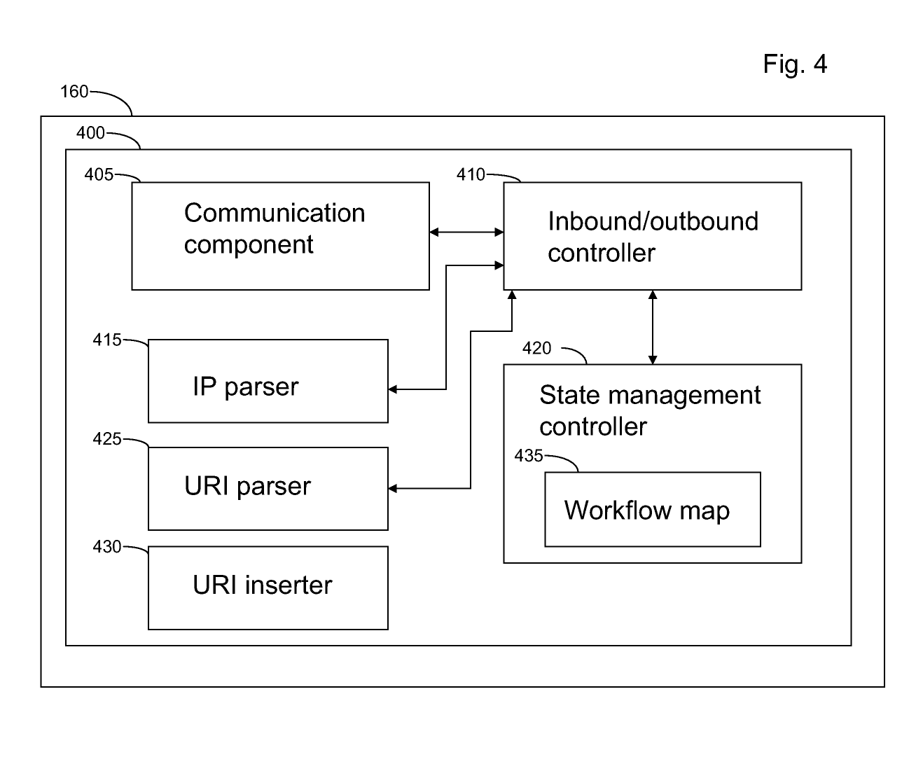

With reference to FIG. 4, in order to provide enhanced navigational functionality the present invention provides an interceptor component 400 for intercepting HTTP headers of requests for resources and responses to requests in order to determine the context of a request/reply interaction between a client and a server. Such that, context sensitive URI's can be attached to HTTP header's for receiving by a browser application for attaching to the attributes of a forward 310 and back 315 button.

In accordance with a preferred embodiment, the present invention provides an interceptor component 400 residing on, preferably, a gateway 160 located on the service provider's local network 150 and is operable for receiving and transmitting requests to and from web servers 130 and client devices 105, 110. The interceptor component 400 comprises a communication component 405 for receiving requests from client devices 105, 110 and responses from web servers 130, an inbound/outbound controller 410 for interfacing with an IP parser component 415, a URI parser component 425 and a URI inserter component 430 and a state management controller 420 comprising a workflow map 435. Each of these components will now be explained in turn.

The communication component 405, in this embodiment, is residing on a gateway 160 and thus receives via the gateway data packets which are either inbound i.e. for a designated web server 130 or outbound for a requesting client device 105, 110.

In an inbound scenario, a client 105, 110 requests a resource by typing in a URI into the browser's address bar. The browser 115, 120 parses the URI and packages the request into an HTTP data packet. On route to the web server 130 the request is passed through a gateway 160 managed by, for example, a service provider. The gateway 160 transmits the request to the interceptor component 400 for determining a pair of URI's for inserting into the HTTP header of the response. The browser 115, 120 on receiving the response parses the HTTP header and identifies the URI's and attaches the URI's to their respective forward and back buttons.

On receipt of the request by the communication component 405, the communication component 405 transmits the request to the inbound/outbound controller 410 for determining whether the data packet is an inbound request or an outbound response. The inbound/outbound controller 410 parses the HTTP header of the data packet identifying HTTP constructs, such as, GET and POST which identify whether the request is an inbound request or an outbound response. The inclusion of GET and POST in the HTTP header identifies an inbound request and the absence of such constructs identifies the data packet as an outbound response.

The inbound/outbound controller 410 on determining whether the data packet is an inbound request or an outbound response interfaces with an IP extractor component 415 and an URI extractor component 425 for extracting the IP address and the URI from the TCP/IP header and the HTTP header. It is important to note, as is known in the art the TCP/IP header encapsulate the HTTP headers. It is the TCP/IP protocol which is concerned with creating open connection with other devices operating on the network.

For example, an HTTP header in an inbound request may be as follows:

Inbound Request

TCP/IP Header
IP address: 129.54.16.200

HTTP Header
GET/index.html HTTP/1.1
Host: www.mymusic/lastestgroovysong/song1

The IP parser component 415 and the URI parser component 430 copy www.mymusic/lastestgroovysong/song1 from the HTTP header and 129.54.16.200 from the TCP/IP header.

The copy of the IP address and the URI are stored, as a key pair, in a state management component 420. On completion of storing the key pair, the intercepted data packet is transmitted from the communication component 405 through the gateway to the receiving web server 130. Wherein the receiving web server 130 locates the requested resource, for example, song1 and returns song1 to the requesting client device 105, 110. An example of an outbound response is shown in example 2.

### EXAMPLE 2

Outbound Response

TCP/IP Header
IP address: 129.54.16.200

HTTP Header
HTTP/1.1 200 OK
Date; Tuesday 22 November 2005 14:19 GMT
Server: Apache/1.3.25
Last modified: Saturday 2 July 2005 12:01 GMT
Content-length 524
Connection: Active
Content type: mps, wav, wmv; charset UTF-16
Body: song1

As the outbound response is transmitted back to the requesting client device 105, 110, the outbound response is received by the gateway 160.

The communication component 405 receives the outbound response and communicates the outbound response to the inbound/outbound controller 410. The inbound/outbound controller 410 parses the outbound response and identifies whether the received data packet is an outbound response or an inbound request. Note: although the invention is being described in terms of inbound and outbound request/response this is for clarity and in practice the gateway receives HTTP data packets on a particular port number and does not know whether the received HTTP stream is an outbound or an inbound request/response. Thus the inbound/outbound controller 410 performs an analysis step to identify which type of HTTP data packet it is.

The inbound/outbound controller 410 makes function calls to the IP parser 415 and requests the IP parser 415 to copy the IP address. Using the IP address, the inbound/outbound controller 410 transmits a request to the state management component 420 requesting a lookup to identify the URI associated with the IP address. This lookup thus represents the URI the client requested.

The state management component 420 receives requests from the inbound/outbound controller 410. The state management component 420 is responsible for identifying URI's to be inserted into the HTTP header for attaching to the forward and back buttons within the browser 115, 120. The state management component 420 receives a communication from the inbound/outbound controller 410 to perform a lookup in the data store 135 using the extracted IP address of the outbound response. The state management component 420 returns the URI associated with the IP address.

The state management component 420, using the identified URI, performs a lookup in the workflow map 435 to locate a URI to navigate back to and a URI to navigate forward to, via the forward 310 and back 315 buttons operational within the browser environment.

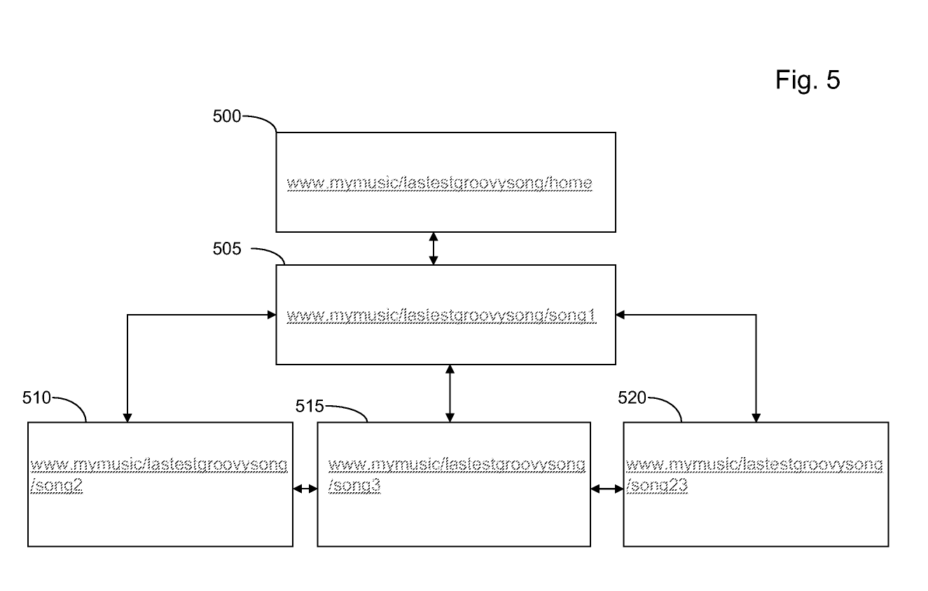

For example, with reference to FIG. 5, the state management component 420 identifies the URI as being:
www.mymusic/lastestgroovysong/song1

Thus the state management component 420 uses the URI to lookup in the workflow map 435 the URI's which can be navigated back to and forwards to via the forward 310 and back 315 buttons within the browser. For example, the URI which can be navigated back to from /song1 505 is /home 500 and the URI which can be navigated forward to from /song1 is /song2 510, /song3 515 or /song4 520.

On locating a URI to navigate forward to and a URI to navigate back to, the pair of URI's is inserted into the HTTP header by the URI inserter component 430. The HTTP constructs used by the URI inserter component 430 may be as follows:
Intelligent_button_forward_action:www.mymusic/lastestgroovysong/song2
Intelligent_button_back_action:www.mymusic/lastestgroovysong/home

The URI inserter component 430 inserts each of these constructs into the HTTP header as follows:

Outbound Response

TCP/IP header
IP address: 129.54.16.200

HTTP Header
HTTP/1.1 200 OK
Date; Tuesday 22 November 2005 14:19 GMT
Server: Apache/1.3.25
Last modified: Saturday 2 July 2005 12:01 GMT
Content-length 524
Connection: Active
Content type: mps, wav, wmv; charset UTF-16
Body: song1
Intelligent_button_forward_action:www.mymusic/lastestgroovysong/song2
Intelligent_button_back action:mymusic/lastestgroovysong/home

The URI inserter component 430 transmits the HTTP header to the communication component 405 for sending onto the requesting client device 105, 110. The client device 105, 110 receives the HTTP header as part of the data packet, in the normal manner, and the browser via the page rendering component 320 processes the HTTP header and attaches the URI's to their respective forward 310 and back buttons 315.

In another embodiment, the IP parser component 415 is replaced by a state token controller 600. This may be appropriate in instances where the gateway 160 receives a number of requests for resources, but the gateway 160 rather than forwarding the requests with the requesting client device's IP address in the TCP/IP header, replaces the IP address with its own.

For example, client device A sends a request for song1 and has an IP address of 192.23.46.100 and client device B sends a request for song1 and has an IP address of 204.46.78.200. The gateway 160 receives these two requests but rather than forwarding the requests with the client's IP address in the TCP/IP headers, the gateway 160 substitutes each of the IP addresses with its own IP address. Hence, when the response arrives back at the gateway 160, the gateway 160 only sees its own IP address and not each of the clients' IP addresses.

Therefore, the state token controller 600 for each request received generates a unique identifier, for example a hexadecimal value, and appends the unique identifier to the HTTP header. The request is then processed in the normal way, as explained with reference to FIG. 4, but in this instance the state token is used to perform a lookup in the data store to locate the URI of the requesting client device.

In a further embodiment the workflow map 435 may comprise additional information pertaining to each web server's 130 load capacity and the inbound/outbound controller 410 is able to perform load balancing operations and direct requests for resources to web servers 130 which are more able to serve the request. The server's 130 operational load information may be updated over a period of time by interfacing with known network management systems, for example.

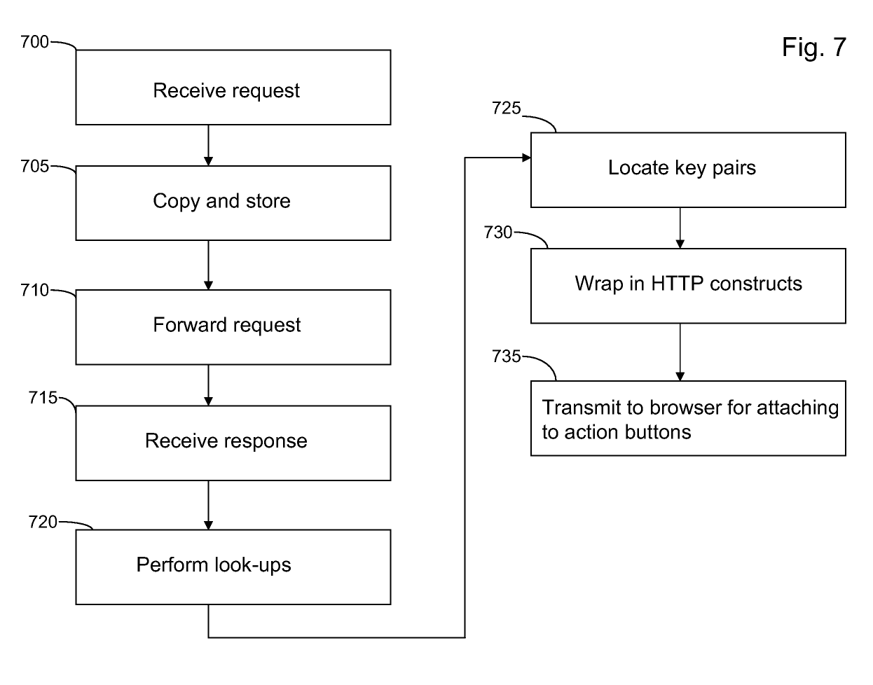

Moving on to FIG. 7, the operational steps of the invention are shown. At step 700, the interceptor component 400 receives, via the communication component 405, a request for a resource. The communication component 405 communicates this request to the inbound/outbound controller 410, wherein the controller 410 interfaces with an IP parser component 415 and a URI parser 425 component to take a copy of the IP address and the URI, at step 705. The copies are communicated to the state management component 420 for storing in key pairs in the data store. At step 710, the request is forwarded onto the web server 130 in the usual manner.

At step 715, the communication component 405 receives the outbound response. The response is transmitted to the inbound/outbound controller 410 and the inbound/outbound controller 410 interacts with the IP parser component to copy the IP address. The IP address is used as a lookup into the data store to locate the URI associated with the IP address at step 720.

The state management component 420 takes the URI and performs a lookup in the workflow map 435 to locate the resources which can be navigated to via a forward and back navigation operation, at step 725.

The pair of URI's is packaged into HTTP constructs, at step 730 and the response is transmitted to the requesting client device at step 735.

The browser at the client device parses the received response and identifies the constructs for the forward and back buttons and attaches the appropriate URI's to the appropriate forward and back buttons.

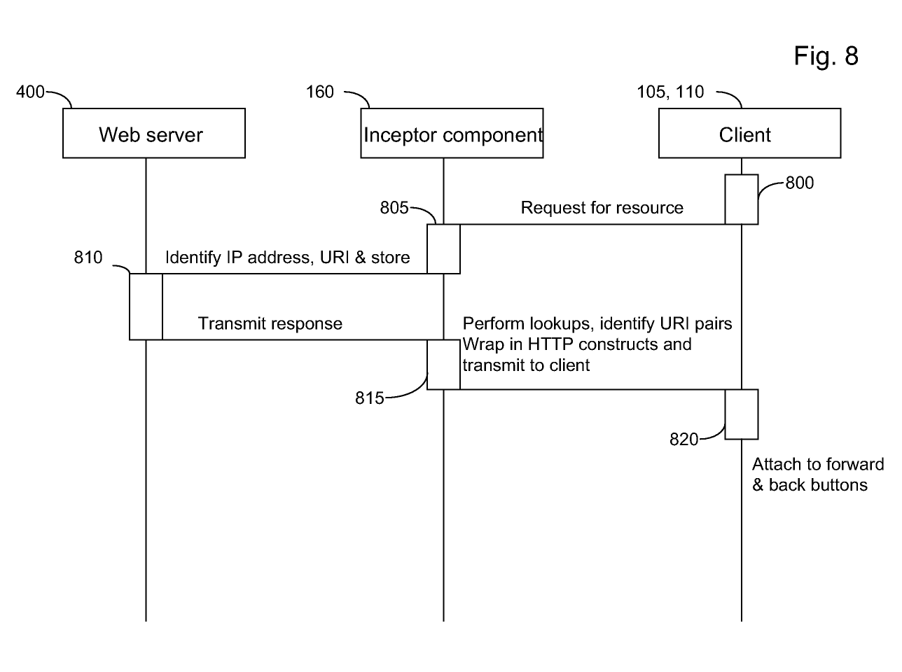

Referring to FIG. 8, a sequence diagram shows the interaction steps between the requesting client device 105, 110, the interceptor component 400 and the web server 130 that will satisfy the request for a resource.

Using sample data—the client device 105, requests via the browser 115, 120, a song from www.mymusic.com, at event 800. The gateway 160 receives the request via port number 80, for example. The gateway 160 before sending the request onto the web server 130 passes the request via the interceptor component 400 and its sub components. The communication component 405 takes the request and transmits it to the inbound/outbound controller 410, which interfaces with an IP parser 415 or a state token component 600 in order to either identify the IP address contained within the TCP/IP header and to store the copy in a data store along and an URI parser to identify and store a copy of the URI with the IP address in a data store (for example, IP address: 102.46.73.200, URI: www.mymusic.com) or a state token component 600 to generate a unique identifier for attaching to the HTTP header (for example, a hexadecimal value), at event 805.

The request is forwarded to the web server 130 that can satisfy the request. The web server 130 receives the requests and identifies, via the URI, which resource is being requested—in this case song number 1 and sends song number 1 back to the requesting client 105, 110, at event 810. Again, the request passes through the gateway 160 and is intercepted by the interceptor component 400. The interceptor component 400 identifies via the inbound/outbound controller 410 whether the request is an inbound request or an outbound response. In this example, the request is an outbound response and the IP address is identified within the TCP/IP header and used as a lookup within the data store to locate the associated URI. On locating the URI, the URI is used to identifying associated URI's which can be navigated forward to and back from. The pair of URI's are wrapped in HTTP constructs and added to the HTTP header, at event 815. The response is transmitted to the requesting client 105, 110 and the browser 115, 120 reads the HTTP header and identifies the presence of the HTTP constructs and attaches the URI's to the respective forward and back buttons, at event 820.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system, (or apparatus or device) or a propagation medium.

Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description but is not intended to exhaust or limit the invention in the form disclosed. Many modifications and variations will be apparent to those of ordinary skill in the art. The embodiments were chosen and described in order to best explain the principles of the invention and the practical application, and to enable others of ordinary skill in the art to understand the invention for various embodiments with various modifications as are suited to the particular use contemplated.

1. An interceptor component for generating a uniform resource locator for associating with a forward navigation button for transmitting to a browser application, the interceptor component comprising:
an inbound/outbound controller for determining whether a received data packet is an inbound request;
a parsing component for identifying a unique identifier and a uniform resource locator of the determined inbound request, storing the unique identifier and the uniform resource locator;
means for the inbound/outbound controller receiving an outbound response to the inbound request and identifying the unique identifier within the outbound response and locating the uniform resource locator associated with the unique identifier; and
means for the inbound/outbound controller performing a look-up to locate a uniform resource locator which can be navigated to in a forward navigation operation and inserting the located uniform resource locator into the outbound response and transmitting the response to a requesting client device.

2. An interceptor component as claimed in claim 1 further comprises means for the inbound/outbound controller locating a uniform resource locator which can be navigated to in a back navigation operation and inserting the located uniform resource locator into the outbound response.

3. An interceptor component as claimed in claim 1 wherein the outbound response is received by a browser operating on a requesting device and the browser application attaches the forward URI to the respective forward button.

4. An interceptor component as claimed in claim 2 wherein the outbound response is received by a browser operating on a requesting device and the browser application attaches the back URI to the respective back button.

5. An interceptor component as claimed in claim 1 wherein the unique identifier is an IP address or a state token.

6. An inceptor component as claimed in claim 1 further comprises a workflow map detailing at least one URI which can be navigated to from the URI identified in the inbound request.

7. An interceptor component as claimed in claim 6 further comprising a state management component for parsing the workflow map to match the URI of the outbound request with a URI identified within a node of the workflow map.

8. An interceptor component as claimed in claim 7 wherein the state management component on identifying a match traverses the workflow map in a plurality of directions to locate URIs which can be navigated to from the URI identified in the outbound response.

9. An interceptor component as claimed in claim 1 wherein each URI is packaged into an HTTP construct for inserting into an HTTP header of the outbound request.

10. An interceptor component as claimed in claim 9 wherein each HTTP construct identifies a forward navigation action and a back navigation action.

11. An interceptor component as claimed 10 wherein the workflow map further comprises data relating to the operating workload capacity of a server identified within the URI.

12. An interceptor component as claimed in claim 11 wherein the inbound/outbound component performs load balancing operations in response to the operating workload capacity of the server.

13. A method of generating a uniform resource locator for associating with a forward navigation button for transmitting to a browser application, the method comprising the steps of:
determining whether a received data packet is an inbound request;
identifying by a parsing component a unique identifier and a uniform resource locator of the determined inbound request, storing the unique identifier and the uniform resource locator;
receiving an outbound response to the inbound request and identifying the unique identifier within the outbound response and locating the uniform resource locator associated with the unique identifier; and
performing a look-up to locate a uniform resource locator which can be navigated to in a forward navigation operation and inserting the located uniform resource locator into the outbound response and transmitting the response to a requesting client device.

14. A method as claimed in claim 13 further comprising locating a uniform resource locator which can be navigated to in a back navigation operation and inserting the located uniform resource locator into the outbound response.

15. A method as claimed in claim 13 wherein the outbound response is received by a browser operating on a requesting device and the browser application attaches the forward URI to the respective forward button.

16. A method as claimed in claim 14 wherein the outbound response is received by a browser operating on a requesting device and the browser application attaches the back URI to the respective back button.

17. A method as claimed in claim 13 wherein the unique identifier is an IP address or a state token.

18. A method as claimed in claim 13 further comprises a workflow map detailing at least one URI which can be navigated to from the URI identified in the inbound request.

19. A method as claimed in claim 18 further comprises the step of parsing the workflow map to match the URI of the outbound response with a URI identified within a node of the workflow map.

20. A method as claimed in claim 19 wherein on identifying a match traverses the workflow map in a plurality of directions to locate URIs which can be navigated to from the URI identified in the outbound response.

21. A method as claimed in claim 13 wherein each URI is packaged into an HTTP construct for inserting into an HTTP header of the outbound response.

22. A method as claimed in claim 21 wherein each HTTP construct identifies a forward navigation action and a back navigation action.

23. A method as claimed 18 wherein the workflow map further comprises data relating to the operating workload capacity of a server identified within the URI.

24. A method as claimed in claim 19 further comprising performing load balancing operations in response to the operating workload capacity of the server.

25. A computer program product comprising storage-type computer readable medium including computer program code, which when executed by a computer cases the computer to perform a method of generating a uniform resource locator for associating with a forward navigation button for transmitting to a browser application, the method comprising:
determining whether a received data packet is an inbound request;
identifying by a parsing component a unique identifier and a uniform resource locator of the determined inbound request, storing the unique identifier and the uniform resource locator;
receiving an outbound response to the inbound request and identifying the unique identifier within the outbound response and locating the uniform resource locator associated with the unique identifier; and
performing a look-up to locate a uniform resource locator which can be navigated to in a forward navigation operation and inserting the located uniform resource locator into the outbound response and transmitting the response to a requesting client device.

26. A browser application for requesting resources from servers operating in a data processing environment and adapted for receiving an outbound response comprising a uniform resource locator for associating with a forward/backward navigation button, the browser application comprising:
a browser component;
an inbound/outbound controller for determining whether a received data packet is an inbound request;
a parsing component for identifying a unique identifier and a uniform resource locator of the determined inbound request, storing the unique identifier and the uniform resource locator;
means for the inbound/outbound controller receiving an outbound response to the inbound request and identifying the unique identifier within the outbound response and locating the uniform resource locator associated with the unique identifier; and
means for the inbound/outbound controller performing a look-up to locate a uniform resource locator which can be navigated to in a forward navigation operation and inserting the located uniform resource locator into the outbound response and transmitting the response to a requesting client device.
